(19) United States
(12) Patent Application Publication
(10) Pub. No.: US 2010/0296665 A1
(43) Pub. Date: Nov. 25, 2010

(54) NOISE SUPPRESSION APPARATUS AND PROGRAM

(75) Inventors: Yohei ISHIKAWA, Tokyo-to (JP); Yu Takahashi, Hamamatsu-shi (JP); Hiroshi Saruwatari, Ikoma-shi (JP); Kazunobu Kondo, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignees: Nara Institute of Science and Technology National University Corporation, Ikoma-shi (JP); Yamaha Corporation, Hamamatsu-Shi (JP)

(21) Appl. No.: 12/782,615

(22) Filed: May 18, 2010

(30) Foreign Application Priority Data
May 19, 2009 (JP) 2009-121192

(51) Int. Cl. H04B 15/00

(52) U.S. Cl. 381/71.1; 381/94.3

(57) ABSTRACT

A In a noise suppression apparatus, an extractor extracts a noise component from an audio signal. A stationary noise estimator estimates stationary noise included in the noise component. A first noise suppressor removes a spectrum of the stationary noise from a spectrum of the audio signal to an extent determined by a subtraction factor. A non-stationary noise estimator estimates a spectrum of non-stationary noise by subtracting the spectrum of the stationary noise from the spectrum of the noise component. A factor setter generates a filtering factor for emphasizing a target sound component contained in the audio signal from the spectrum of the non-stationary noise. A second noise suppressor performs a filtering process using the filtering factor on the audio signal after processing of the first noise suppressor. An index calculator calculates a kurtosis change index representing an extent of change of kurtosis in a frequence distribution of magnitude of the audio signal between the kurtosis observed when processing of the first noise suppression part is performed and the kurtosis observed when processing of the second noise suppression part is performed. A factor adjuster variably controls the subtraction factor according to the kurtosis change index.

### BACKGROUND OF THE INVENTION

1. Technical Field of the Invention

The present invention relates to a technology for suppressing noise components in an audio signal.

2. Description of the Related Art

A technology for suppressing noise components in a sound mixture of target sound components and noise components has been suggested. For example, Japanese Patent Application Publication No. 2007-248534 describes a technology for subtracting a spectrum of noise components estimated through independent component analysis from a spectrum of an audio signal in which target sound components have been emphasized through a delay sum type beamformer.

However, in the technology for suppressing noise components in the frequency domain as in Japanese Patent Application Publication No. 2007-248534, components remaining in the time axis and the frequency axis after suppression of noise components are perceived as artificial and harsh musical noise by the listener. Reducing the extent of subtraction of noise components decreases musical noise but has a problem in that noise components cannot be sufficiently suppressed (i.e., the SN ratio is low after noise component suppression).

### SUMMARY OF THE INVENTION

In view of these circumstances, it is an object of the invention to achieve both reduction in musical noise and effective suppression of noise components.

In order to solve the problem, according to the invention, an apparatus is provided for suppressing noise components from audio signals of a plurality of channels generated by a plurality of sound collecting devices, the inventive apparatus comprising: a noise extraction part that extracts a noise component from an audio signal of each of the plurality of channels; a stationary noise estimation part that estimates stationary noise included in the noise component; a first noise suppression part that removes a spectrum of the stationary noise from a spectrum of the audio signal of each of the plurality of channels to an extent determined according to a subtraction factor; a non-stationary noise estimation part that estimates a spectrum of non-stationary noise by subtracting the spectrum of the stationary noise from the spectrum of the noise component of each of the plurality of channels; a factor setting part that generates a filtering factor for emphasizing a target sound component contained in the audio signal from the spectrum of the non-stationary noise; a second noise suppression part that performs a filtering process using the filtering factor on the audio signals of the plurality of channels after processing of the first noise suppression part; an index calculation part that calculates a kurtosis change index representing an extent of change of kurtosis in a frequence distribution of magnitude of each of the audio signals between the kurtosis observed when processing of the first noise suppression part is performed and the kurtosis observed when processing of the second noise suppression part is performed; and a factor adjustment part that variably controls the subtraction factor according to the kurtosis change index.

In this embodiment, it is possible to effectively suppress noise components while suppressing musical noise caused by the processing of the first noise suppression part since the subtraction factor used for the processing of the first noise suppression part is variably controlled according to the kurtosis change index representing the extent of change of the kurtosis in the frequence distribution of the magnitude of each of the audio signals from the kurtosis observed when the processing of the first noise suppression part is performed to the kurtosis observed when the processing of the second noise suppression part is performed.

In a preferred embodiment of the invention, the factor adjustment part controls the subtraction factor such that the kurtosis change index approaches a predetermined value. In this embodiment, it is possible to effectively suppress noise components while suppressing musical noise caused by the processing of the first noise suppression part to a desired extent according to the predetermined value.

The noise suppression apparatus according to the invention may not only be implemented by hardware (electronic circuitry) such as a Digital Signal Processor (DSP) dedicated to noise suppression but may also be implemented through cooperation of a general arithmetic processing unit such as a Central Processing Unit (CPU) with a program. The program according to the invention is executable by the computer to perform: a noise extraction process of extracting a noise component from an audio signal of each of a plurality of channels generated by a plurality of sound collecting devices; a stationary noise estimation process of estimating stationary noise included in the noise component; a first noise suppression process of removing a spectrum of the stationary noise from a spectrum of the audio signal of each of the plurality of channels to an extent determined according to a subtraction factor; a non-stationary noise estimation process of estimating a spectrum of non-stationary noise by subtracting the spectrum of the stationary noise from the spectrum of the noise component of each of the plurality of channels; a factor setting process of generating a filtering factor for emphasizing a target sound component contained in the audio signal from the spectrum of the non-stationary noise; a second noise suppression process of performing a filtering process using the filtering factor on the audio signals of the plurality of channels after the first noise suppression process is performed; an index calculation process of calculating a kurtosis change index representing an extent of change of kurtosis in a frequence distribution of magnitude of each of the audio signals between the kurtosis observed when the first noise suppression process is performed and the kurtosis observed when the second noise suppression process is performed; and a factor adjustment process of variably controlling the subtraction factor according to the kurtosis change index.

The program achieves the same operations and advantages as those of the noise suppression apparatus according to each embodiment of the invention. The program of the invention may be provided to a user through a computer machine readable recording medium storing the program and then installed on a computer and may also be provided from a server apparatus to a user through distribution over a communication network and then installed on a computer.

### BRIEF DESCRIPTION OF THE DRAWINGS

FIG. 1 is a block diagram of a noise suppression apparatus according to an embodiment.

FIGS. 2(A) and 2(B) are conceptual diagrams illustrating change of kurtosis of a frequence distribution of the magnitude of an audio signal.

FIGS. 3(A) and 3(B) are conceptual diagrams illustrating operation of directional array process.

FIG. 4 is a graph illustrating a relationship between a subtraction factor and a kurtosis change index.

FIG. 5 is a graph illustrating a relationship between a subtraction factor and a noise suppression ratio.

FIG. 6 is a flow chart of operation of the noise suppression apparatus.

FIG. 7 is a graph illustrating advantages of the embodiment.

FIG. 8 is a graph illustrating advantages of the embodiment.

FIG. 9 is a block diagram of a noise extractor according to a modification.

FIG. 10 is a block diagram of a noise extractor according to another modification.

### DETAILED DESCRIPTION OF THE INVENTION

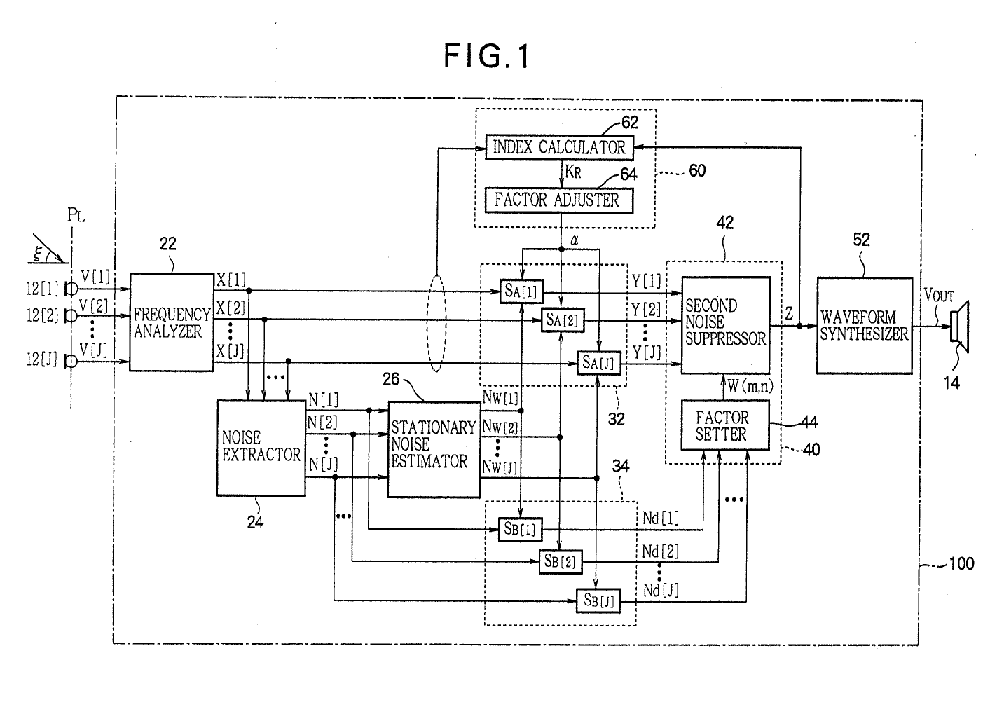

FIG. 1 is a block diagram of a noise suppression apparatus 100 according to an embodiment of the invention. A plurality of sound collecting devices 12[1] to 12[J] (J=a natural integer greater than 1) constitute a microphone array, and are arranged in a plane PL at predetermined intervals and connected to the noise suppression apparatus 100. The sound collecting device 12[j] (j=1˜J) generates an audio signal V[j] of the time domain representing a waveform of sound which arrives at the sound collecting device 12[j] (j=1˜J) from surroundings. The symbol j is a channel number of the audio signal V[j].

A sound mixture of target sound components and noise components from surroundings arrives at the sound collecting devices 12[1] to 12[J]. The target sound components are components of a target sound (vocal or musical sound) to be received. The target sound components arrive at the sound collecting devices 12[1] to 12[J] from a direction at a known angle ξ with respect to normal to the plane PL. For example, in the case where the noise suppression apparatus 100 is installed in an electronic device (for example, a portable phone) to which voice of the user is input, voice arriving at the electronic device from a direction (ξ=0°) corresponding to the front side of the body of the electronic device corresponds to the target sound components.

On the other hand, the noise components are components other than the target sound components and may include stationary noise (i.e., constant noise) and non-stationary noise (i.e., fluctuating noise). The stationary noise is components which undergo little or no temporal change in acoustic characteristics (for example, sound pressure). For example, the stationary noise corresponds to operating noise of air-conditioning equipment or noise in crowds. On the other hand, the non-stationary noise is instantaneous components that undergo a temporal change in acoustic characteristics from moment to moment. For example, the non-stationary noise corresponds to vocal sound (speech sound) or musical sound other than the target sound components.

The noise suppression apparatus 100 generates an audio signal V_{OUT} of the time domain by performing a process for suppressing noise components (stationary noise and non-stationary noise) on audio signals V[1] to V[J]. The audio signal V_{OUT} generated by the noise suppression apparatus 100 is provided to a sound emitting device 14 (for example, a speaker or headphones) and the sound emitting device 14 reproduces the audio signal V_{OUT} as physical sound. An A/D converter for converting the audio signals V[1] to V[J] into digital signals, a D/A converter for converting the audio signal V_{OUT} into an analog signal, or the like are not illustrated for the sake of convenience.

The noise suppression apparatus 100 is implemented as an arithmetic processing device that performs a plurality of functions (such as functions of a frequency analyzer 22, a noise extractor 24, a stationary noise estimator 26, a first noise suppressor 32, a non-stationary noise estimator 34, a filtering processor 40, a waveform synthesizer 52, and a suppression controller 60) by executing a program stored in a storage device (not shown). However, it is also possible to employ a configuration in which an electronic circuit (DSP) dedicated to noise suppression implements each component of FIG. 1 or a configuration in which each component of FIG. 1 is distributed over a plurality of integrated circuits.

For each of the channels of the audio signals V[1] to V[J], the frequency analyzer 22 generates a spectrum (power spectrum) X[j] (X[1] to X[J]) for each of the frames into which the audio signal V[j] is divided along the time axis. The spectrum X[j] is a series of respective magnitudes (power) of a predetermined number of frequencies discretely set along the frequency axis. Any known technology (for example, short-time Fourier transform) may be used to generate the spectrum X[j].

The noise extractor 24 extracts a noise component from the audio signal V[j] of each channel at each frame. Specifically, the noise extractor 24 generates noise component spectrum (power spectrum) N[j] (N[1] to N[J]) in each frame. In a noise section of the audio signal V[j] in which target sound components are not present, the spectrum X[j] matches the noise component spectrum N[j]. Therefore, the noise extractor 24 divides the audio signal V[j], which is a time series of the spectrum X[j], into target sound sections and noise sections along the time axis and specifies the spectrum X[j] of each frame in the noise section as a noise component spectrum N[j]. Any known voice activity detection (VAD) technology may be used to divide the audio signal V[j] into target sound sections and noise sections.

The stationary noise estimator 26 estimates stationary noise included in the noise component of each channel extracted by the noise extractor 24. The stationary noise is a temporally stationary component among the noise components as described above. Here, the stationary noise estimator 26 generates a stationary noise spectrum (power spectrum) Nw[j] (Nw[1] to Nw[J]) by averaging (specifically, time-averaging) the noise component' spectrums N[j] generated by the noise extractor 24 over a plurality of frames in the noise section. Averaging the spectrum N[j] removes non-stationary noise from the spectrum Nw[j]. The stationary noise spectrum Nw[j] is sequentially updated in each noise section. That is, a spectrum Nw[j] estimated in a noise section immediately previous to a target sound section is maintained during the noise sound section.

For each channel, the first noise suppressor 32 suppresses stationary noise included in the audio signal V[j] in the frequency domain. As shown in FIG. 1, the first noise suppressor 32 includes the same number (J) of subtractors S_{A}[1] to S_{A}[J] as the total number of the channels of the audio signals V[1] to V[J]. The subtractor S_{A}[j] corresponding to the jth channel generates a spectrum (power spectrum) Y[j] (Y[1] to Y[J]) in each frame by subtracting the stationary noise spectrum Nw[j] from the spectrum X[j] of the audio signal V[j] (through spectrum subtraction) in the frequency domain. Specifically, the subtractor S_{A}[j] calculates the spectrum Y[j] through calculation of the following Equations (1a) and (1b).

$$Y [ j ] = \{ \begin{matrix}X [ j ] - α \cdot Nw [ j ] & ( X [ j ] \geq Th 1 ) \\ β \cdot X [ j ] & ( otherwise )\end{matrix} \qquad \begin{matrix}( 1 a ) \\ ( 1 b )\end{matrix}$$

That is, the subtractor S_{A}[j] calculates the spectrum Y[j] by subtracting the product of the stationary noise spectrum Nw[j] and a subtraction factor α from the spectrum X[j] for frequencies in which the spectrum X[j] of the audio signal V[j] is equal to or higher than a threshold Th1 as shown in Equation (1a). On the other hand, the subtractor S_{A}[j] calculates the spectrum Y[j] by multiplying the spectrum X[j] by a flooring factor β for frequencies in which the spectrum X[j] of the audio signal V[j] is less than the threshold Th1 as shown in Equation (1b). For example, the threshold Th1 is set to the product of the subtraction factor α and the spectrum Nw[j]. As can be seen from the Equations (1a) and (1b), the subtraction factor α serves as a numerical value determining the extent of suppression of noise components (stationary noise). That is, the effect of suppression of stationary noise (i.e., the performance of noise suppression) increases as the subtraction factor α increases.

The non-stationary noise estimator 34 estimates a non-stationary noise spectrum (power spectrum) Nd[j] (Nd[1] to Nd[J]) included in the audio signal V[j] of each channel in each frame. As shown in FIG. 1, the non-stationary noise estimator 34 includes the same number (J) of subtractors S_{B}[1] to S_{B}[J] as the total number of the channels of the audio signals V[1] to V[J].

The noise components are a mixture of stationary noise and non-stationary noise. Therefore, the subtractor S_{B}[j] corresponding to the jth channel generates a non-stationary noise spectrum Nd[j] (Nd[1] to Nd[J]) in each frame in the noise section by subtracting the stationary noise spectrum Nw[j] from the spectrum N[j] of each frame in the noise section specified by the noise extractor 24 (through spectrum subtraction) in the frequency domain. In each frame in the target sound section, a spectrum Nd[j] of the last frame of an immediately previous noise section is continuously output from the subtractor S_{B}[j].

Non-stationary noise in each frame in the target sound section is not directly extracted from the target sound section as described above. However, for example, when the target sound components are voice of one person, noise sections and target sound sections alternate at sufficiently small time intervals, compared to the speed of change of non-stationary noise. Accordingly, the accuracy of noise suppression is not excessively reduced even though the spectrum Nd[j] extracted from each frame in the noise section is used as the spectrum Nd[j] of the non-stationary noise in the target sound section.

The following Equations (2a) and (2b) are applied when the subtractor S_{B}[j] calculates the spectrum Nd[j].

$$Nd [ j ] = \{ \begin{matrix}N [ j ] - δ \cdot Nw [ j ] & ( N [ j ] \geq Th 2 ) \\ ɛ & ( otherwise )\end{matrix} \qquad \begin{matrix}( 2 a ) \\ ( 2 b )\end{matrix}$$

That is, the subtractor S_{B}[j] calculates the spectrum Nd[j] by subtracting the product of the stationary noise spectrum Nw[j] and a factor δ from the noise component spectrum N[j] for frequencies in which the noise component spectrum N[j] is equal to or higher than a threshold Th2 (for example, the product of the spectrum Nw[j] and a factor δ) as shown in Equation (2a). On the other hand, the spectrum Nd[j] of non-stationary noise is set to a predetermined value ε for frequencies in which the noise component spectrum N[j] is less than the threshold Th2 as shown in Equation (2b). For example, the predetermined value ε is set to the product of the noise component spectrum N[j] and a predetermined factor.

Since target sound components, stationary noise, and non-stationary noise are mixed in the audio signal V[j], the spectrum Y[j] after suppression of stationary noise by the first noise suppressor 32 includes the target sound components and the non-stationary noise. For each frame, the filtering processor 40 sequentially generates a spectrum (power spectrum) Z of an audio signal V_{OUT} in which the target sound components have been emphasized (i.e., the non-stationary noise has been suppressed) from the spectrums Y[1] to Y[J] after suppression of stationary noise. The waveform synthesizer 52 converts the spectrum Z of each frame generated by the filtering processor 40 into a time-domain signal through inverse Fourier transform and connects, on the time axis, the converted signals of adjacent frames to generate an audio signal V_{OUT}. The phase spectrum of any of the audio signals V[1] to V[J] is used to generate the audio signal V_{OUT}.

As shown in FIG. 1, the filtering processor 40 includes a second noise suppressor 42 and a factor setter 44. The second noise suppressor 42 generates the spectrum Z of each frame by performing signal processing for emphasizing target sound components (i.e., a filtering process) on the spectrums Y[1] to Y[J] generated through processing by the first noise suppressor 32. The signal processing performed by the second noise suppressor 42 is a directional array process using a filtering factor W set so as to emphasize the target sound components. Here, a filtering process for forming a beam (corresponding to a region with high sound receiving sensitivity) directed toward the target sound component arrival direction (of the angle ξ) or a filtering process for forming a beam with a blind area set in a (non-stationary) noise component arrival direction is preferably employed as the directional array process. Specifically, the second noise suppressor 42 performs a delay sum array process which sums the spectrums Y[1] to Y[J] after adding delay thereto according to the filtering factor W.

The factor setter 44 generates the filtering factor W to be applied to the process of the second noise suppressor 42. Specifically, the factor setter 44 generates the filtering factor W for emphasizing the target sound components through an adaptive beamformer using the non-stationary noise spectrums Nd generated by the non-stationary noise estimator 34. For example, a minimum variance distortionless response (MVDR) is preferably employed as the adaptive beamformer, which determines the filtering factor W so as to minimize the magnitude of noise components (non-stationary noise) arriving from the direction of the angle ξ while maintaining the magnitude of target sound components arriving from the direction.

Specifically, the factor setter 44 calculates a filtering factor W(fq) of each frequency (fq) (q=1, 2, . . . ) according to the following Equation (3). The filtering factor W(fq) is generated, for example, sequentially in each frame.

$$W ( fq ) = \frac{{R}_{NN}^{- 1} ( fq ) d ξ ( fq )}{d {ξ ( fq )}^{H} {R}_{NN}^{- 1} ( fq ) d ξ ( fq )} \qquad ( 3 )$$

The symbol R_{NN}(fq) in Equation (3) is a covariance matrix of the respective magnitudes of the component of the frequency fq in the spectrums Nd[1] to Nd[J]. That is, the covariance matrix R_{NN}(fq) is defined according to the following. Equation (4) using a vector v_{N}(fq) (=[Nd[1](fq), Nd[2](fq), . . . , Nd[J](fq)]^{T}) whose elements are the magnitudes Nd[1](fq) to Nd[j](fq) at the frequency (fq) in the spectrums Nd[1] to Nd[J], where T denotes transposition.

R_{NN}(fq)=E[v_{N}(fq)v_{N}(fq)^{H}] (4)

The symbol H in Equations (3) and (4) denotes Hermitian transposition of the matrix. The symbol “E[ ]” in Equation (4) denotes an average (expectation) or sum over a predetermined number of frames including the current frame (for example, the current frame and a predetermined number of previous frames). The predetermined value ε of Equation (2b) is preferably set to a number other than zero so that an inverse matrix of the covariance matrix R_{NN}(fq) used for calculation of the filtering factor W(fq) of Equation (3) exists.

The symbol dξ(fq) of Equation (3) is a steering vector (direction control vector) of J rows and 1 column representing the differences of times when sound waves (plane waves) of the frequency (fq) arrive at the sound collecting devices 12[1] to 12[J] from the direction of the angle ξ. The factor setter 44 generates the steering vector dξ(fq) of Equation (3) according to the known target sound component arrival angle ξ. When the angle ξ is unknown, the factor setter 44 generates the steering vector dξ (fq) after estimating the target sound component angle ξ. Any known technology such as a MUSIC method or an ESPRIT method may be employed to estimate the angle ξ. The invention also preferably employs a beam-forming method in which beams are formed in a plurality of directions in the directional array process (delay sum array process) and the direction of a beam in which the volume of the audio signals V[1] to V[J] is maximized is specified as the angle ξ. The spectrum Z in which the target sound components have been emphasized is sequentially generated for each frame by applying the filtering factor W(fq) generated in the above procedure to the directional array process performed by the second noise suppressor 42.

However, the spectrum subtraction process, which the first noise suppressor 32 performs to subtract the spectrum Nw[j] from the spectrum X[j] of the audio signal V[j] in the frequency domain, generates high-magnitude components (acnodes) that are distributed over the time axis and the frequency axis, causing musical noise which is artificial and harsh. Generation of musical noise through the spectrum subtraction is described in detail below.

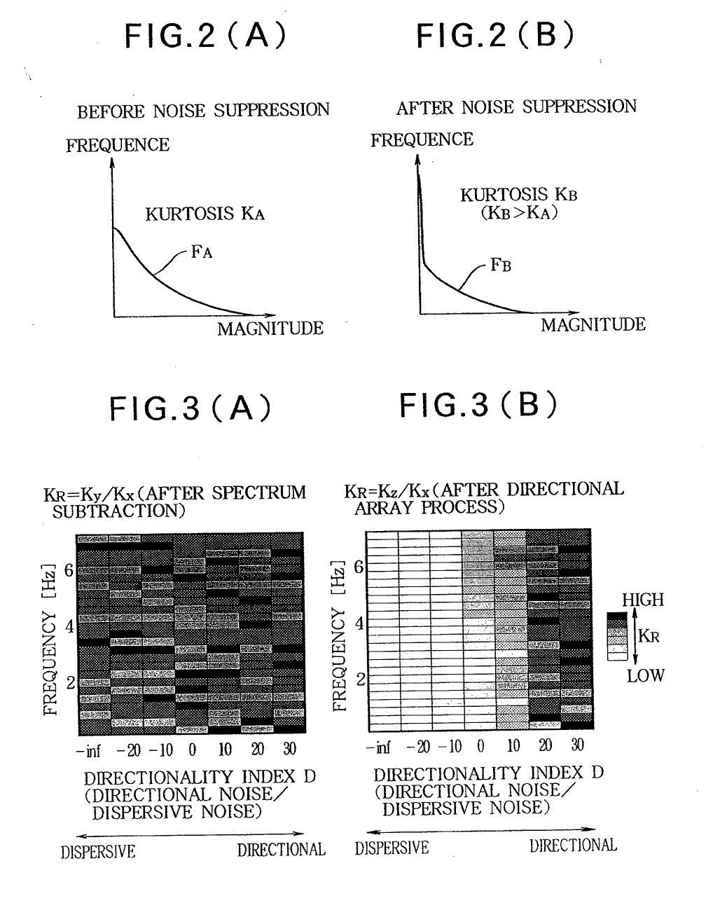

FIG. 2(A) is a graph of a frequence distribution F_{A} (a probability density function whose random variable is the magnitude) of the magnitude of the spectrum X[j] over a predetermined number of frames before processing by the first noise suppressor 32. As shown in FIG. 2(A), the frequence (probability) of the magnitude before the spectrum subtraction is nonlinearly distributed such that the frequence decreases as the magnitude increases from zero. On the other hand, FIG. 2(B) is a graph of a frequence distribution F_{B} of the magnitude (for example, the magnitude of the spectrum Y[j] or the spectrum Z) over a predetermined number of frames after processing by the first noise suppressor 32. Since the frequence (probability) of the magnitude, the value of which is close to zero, is increased through the calculation by the first noise suppressor 32, the distribution of a section in the frequence distribution F_{B} in which the value of the magnitude is close to zero has a steep shape, compared to the frequence distribution F_{A} of the magnitude before spectrum subtraction.

When kurtosis is introduced as a measure of the shape of the frequence distribution of the magnitude (the extent of inclination thereof), the kurtosis K_{B} of the frequence distribution F_{B} of the signal magnitude after spectrum subtraction is greater than the kurtosis K_{A} of the frequence distribution F_{A} of the signal magnitude before spectrum subtraction (K_{B}>K_{A}). Taking into consideration the fact that kurtosis is a measure of Gaussianity, it is understood that non-Gaussianity of the frequence distribution increases as stationary noise which has high Gaussianity in the frequence distribution of the magnitude among the audio signal V[j] is suppressed by the first noise suppressor 32. Since musical noise has high non-Gaussianity (i.e., has high frequence in magnitudes near zero), musical noise tends to develop as the kurtosis increases through spectrum subtraction.

Accordingly, the extent of change of kurtosis of the frequence distribution of signal magnitude, which will hereinafter be referred to as a “kurtosis change index K_{R}38 serves as a quantitative index of the extent of musical noise due to spectrum subtraction. In the following, the kurtosis change index K_{R} is exemplified by the ratio of the kurtosis K_{B} after spectrum subtraction to the kurtosis K_{A} before spectrum subtraction (i.e., K_{R}=KB/K_{A}). As is understood from the following definitions, musical noise becomes apparent or remarkable as the kurtosis change index K_{R} increases (i.e., as the change of the kurtosis increases).

FIGS. 3(A) and (B) are graphs (distribution charts) illustrating the kurtosis change index K_{R} at each frequency denoted on the vertical axis. A region with higher hatching density indicates that the kurtosis change index K_{R} in the region is higher (i.e., that musical noise more easily occurs). The kurtosis change index K_{R} of FIG. 3(A) is the ratio (K_{y}/Kₓ) between the kurtosis Kₓ (the average of the spectrums X[1] to X[J]) in the frequence distribution of the magnitude of the spectrum X[j] before processing by the first noise suppressor 32 and the kurtosis K_{y} (the average of the spectrums Y[1] to Y[J]) in the frequence distribution of the magnitude of the spectrum Y[j] immediately after processing by the first noise suppressor 32. On the other hand, the kurtosis change index K_{R} of FIG. 3(A) is the ratio (K_{z}/Kₓ) between the kurtosis Kₓ (the average of the spectrums X[1] to X[J]) in the frequence distribution of the magnitude of the spectrum X[j] before processing by the first noise suppressor 32 and the kurtosis K_{z} (the average of the spectrums Z[1] to Z[J]) in the frequence distribution of the magnitude of the spectrum Z after the directional array process by the second noise suppressor 42. That is, the kurtosis change index K_{R} is changed from that of FIG. 3(A) to that of FIG. 3(B) through the directional array process by the second noise suppressor 42.

The kurtosis change indices K_{R} of FIGS. 3(A) and 3(B) are measured values when noise components (white Gaussian noise) in which directional noise and dispersive noise are mixed have occurred. The directional noise is noise components that arrive in an oriented manner at the sound collecting devices 12[1] to 12[J] from a single direction (or from a small range of directions), and the dispersive noise is noise components that arrive in a dispersed manner at the sound collecting devices 12[1] to 12[J] from a plurality of directions. The horizontal axis in FIGS. 3(A) and 3(B) represents the ratio of the magnitude of the directional noise to the magnitude of the dispersive noise, which will hereinafter be referred to as a “directionality index D”. The dominance of the directional noise increases (i.e., directionality increases) as the directionality index D increases and the dominance of the dispersive noise increases (i.e., dispersiveness increases) as the directionality index D decreases.

Since the directional array process (delay sum array process) of the filtering processor 40 of FIG. 1 acts to decrease the non-Gaussianity of the signal (according to the central limit theorem), the kurtosis change index K_{R} is sufficiently reduced through the directional array process after spectrum subtraction in the case where the dispersiveness of the noise components is high as shown in FIGS. 3(A) and 3(B). That is, musical noise is sufficiently suppressed through the directional array process when the dispersiveness of the noise components is high. On the other hand, even after the directional array process is performed, the kurtosis change index K_{R} tends to maintain a high value similar to that of immediately after spectrum subtraction as shown in FIGS. 3(A) and 3(B) in the case where the directionality of the noise components is high. That is, the directional array process hardly contributes to suppression of musical noise when the directionality of the noise components is high. Such a tendency is present throughout a wide range of frequencies as shown in FIGS. 3(A) and 3(B).

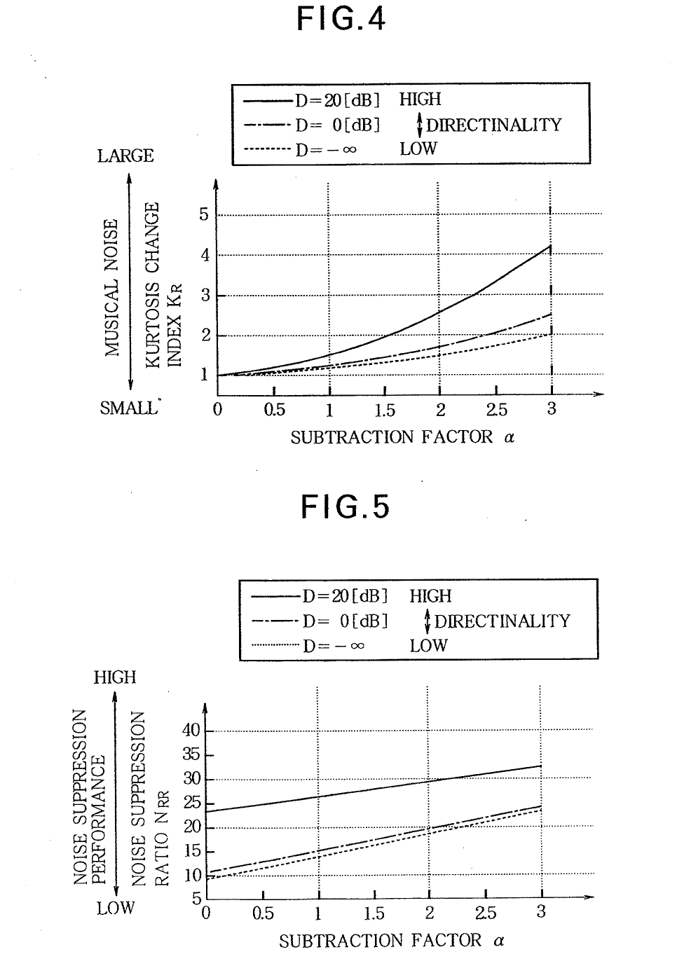

FIG. 4 is a graph illustrating a relationship between the subtraction factor α (horizontal axis) in Equation (1a) and the kurtosis change index K_{R} (vertical axis) for each directionality index D. FIG. 5 is a graph illustrating a relationship between the subtraction factor α (horizontal axis) in Equation (1a) and the noise suppression ratio N_{RR} (vertical axis) for each directionality index D. Each of FIGS. 4 and 5 illustrates the relationship when the noise components are dispersive noise alone (D=−∞), when dispersive noise and directional noise are mixed at the same ratio (D=0), and when the directional noise is dominant (D=20).

Similar to FIG. 3(B), the kurtosis change index K_{R} of FIG. 4 is the ratio (K_{z}/Kₓ) between the kurtosis Kₓ (of the spectrum X[j]) before processing by the first noise suppressor 32 and the kurtosis K_{z} (of the spectrum Z) after the directional array process is performed by the second noise suppressor 42. However, the kurtosis change index K_{R} of FIG. 4 is an average over all frequencies. The noise suppression ratio N_{RR} of FIG. 5 is the difference between an SN ratio Rₒᵤₜ of the audio signal V_{OUT} after processing by the noise suppression apparatus 100 and an SN ratio R_{In} of the audio signal V[j] before processing by the noise suppression apparatus 100 (i.e., N_{RR}=R_{OUT}−R_{IN}). Accordingly, it can be estimated that the effects (or performance) of noise suppression increase as the noise suppression ratio N_{RR} increases. As shown in FIGS. 4 and 5, musical noise more easily occurs (i.e., the kurtosis change index K_{R} of FIG. 4 increases) and the effects of noise suppression increase (i.e., the noise suppression ratio N_{RR} of FIG. 5 increases) as the subtraction factor α increases.

As is understood from FIG. 4, in the case where the directionality of the noise components is high (for example, D=20), the kurtosis change index K_{R} greatly increases as the subtraction factor α increases, compared to the case where the dispersiveness of the noise components is high (for example, D=−∞). On the other hand, in the case where the directionality of the noise components is high, the noise suppression ratio N_{RR} is sufficiently high even when the subtraction factor α is small, compared to when the dispersiveness of the noise components is high. That is, in the configuration of FIG. 1, in the case where the directionality of the noise components is high, the noise suppression ratio N_{RR} is maintained at a high value even when the subtraction factor α is set to a low value so as to suppress musical noise.

In addition, as is understood from FIG. 5, in the case where the dispersiveness of the noise components is high (for example, D=−∞), the noise suppression ratio N_{RR} is low compared to the case where the directionality of the noise components is high. On the other hand, in the case where the dispersiveness of the noise components is high, the kurtosis change index K_{R} is small (i.e., musical noise hardly occurs) even when the subtraction factor α is set to a high value as shown in FIG. 4 since musical noise is effectively reduced through the directional array processing by the second noise suppressor 42 as is described above with reference to FIG. 3. That is, in the configuration of FIG. 1, in the case where the dispersiveness of the noise components is high, musical noise is effectively reduced even when the subtraction factor α is set to a high value in order to maintain the noise suppression ratio N_{RR} at a high value.

Taking into consideration the above tendency, the suppression controller 60 of FIG. 1 variably controls the subtraction factor α according to the kurtosis change index K_{R}. As shown in FIG. 1, the suppression controller 60 includes an index calculator 62 and a factor adjuster 64. The index calculator 62 calculates the kurtosis change index K_{R} for each frame. Calculation of the kurtosis change index K_{R} is described in detail below.

Kurtosis κ is a high-order statistical quantity calculated from an nth-order moment μₙ according to the following Equation (5). For further details, reference is made to co-pending U.S. patent application Ser. No. 12/499,734. The contents of the co-pending application are incorporated herein by reference.

$$κ = \frac{{μ}_{4}}{{μ}_{2}^{2}} - 3 \qquad ( 5 )$$

The frequence distribution (probability density function) of M samples of magnitudes x₁ to x_{M} is approximated by a function Ga(x; k,θ) in the following Equation (6).

$$Ga ( x ; k , θ ) = C \cdot {x}^{k - 1} \cdot exp ( - \frac{x}{θ} ) \\ γ = log ( \frac{1}{M} {\sum }_{i = 1}^{M} {x}_{i} ) - \frac{1}{M} {\sum }_{i = 1}^{M} log {x}_{i} \\ k = \frac{3 - γ + \sqrt{{( γ - 3 )}^{2} + 24 γ}}{12 γ} \\ θ = \frac{1}{Mk} {\sum }_{i = 1}^{M} {x}_{i} \qquad ( 6 )$$

The factor C of Equation (6) is defined as follows using a gamma function Γ(k).

$$C = \frac{1}{{θ}^{k} Γ ( k )}$$

$$\begin{matrix}Γ ( k ) = {\int }_{0}^{∞} {x}^{( k - 1 )} \cdot exp ( - x ) d x \\ = ( k - 1 ) Γ ( k - 1 ) \\ = ( k - 1 ) !\end{matrix}$$

The frequence distribution (probability density function) P(x) in an equation defining the 2nd-order moment μ₂ is replaced with the function Ga(x; k,θ) of Equation (6) to derive the following Equation (7).

$$\begin{matrix}{μ}_{2} = {\int }_{0}^{∞} {x}^{2} \cdot P ( x ) d x \\ = {\int }_{0}^{∞} {x}^{2} [ C \cdot {x}^{( k - 1 )} \cdot exp ( - \frac{x}{θ} ) ] d x \\ = C \cdot {θ}^{( k + 2 )} {\int }_{0}^{∞} {X}^{( k + 2 ) - 1} \cdot exp ( - X ) d X ( X = \frac{x}{θ} ) \\ = C \cdot {θ}^{( k + 2 )} \cdot Γ ( k + 2 )\end{matrix} \qquad ( 7 )$$

Similar to the derivation of the 2nd-order moment μ₂, the frequence distribution (probability density function) P(x) in an equation defining the 4th-order moment μ₄ is replaced with the function Ga(x; k,θ) of Equation (6) to derive the following Equation (8).

$$\begin{matrix}{μ}_{4} = {\int }_{0}^{∞} {x}^{4} \cdot P ( x ) d x \\ = {\int }_{0}^{∞} {x}^{4} [ C \cdot {x}^{( k - 1 )} \cdot exp ( - \frac{x}{θ} ) ] d x \\ = C \cdot {θ}^{( k + 4 )} \cdot Γ ( k + 4 )\end{matrix} \qquad ( 8 )$$

Then, the 2nd-order moment μ₂ of Equation (7) and the 4th-order moment μ₄ of Equation (8) are substituted into Equation (5) to derive the following Equation (9) which defines the kurtosis κ.

$$\begin{matrix}κ = \frac{{μ}_{4}}{{μ}_{2}^{2}} - 3 \\ = \frac{C \cdot {θ}^{( k + 4 )} Γ ( k + 4 )}{{[ C \cdot {θ}^{( k + 2 )} Γ ( k + 2 ) ]}^{2}} - 3 \\ = \frac{\frac{1}{{θ}^{k} Γ ( k )} \cdot {θ}^{( k + 4 )} \cdot ( k + 3 ) ( k + 2 ) ( k + 1 ) k Γ ( k )}{[ \frac{1}{{θ}^{k} Γ ( k )} \cdot {θ}^{( k + 2 )} \cdot ( k + 1 ) k Γ ( k ) ]} - 3 \\ = \frac{( k + 3 ) ( k + 2 )}{( k + 1 ) k} - 3\end{matrix} \qquad ( 9 )$$

The index calculator 62 of FIG. 1 calculates the kurtosis Kₓ before spectrum subtraction by performing the calculation of Equation (9) for the M samples of magnitudes x₁ to x_{M} of the spectrums X[1] to X[J] over a predetermined number of frames including a target frame that is subjected to calculation of the kurtosis change index K_{R} (for example, the target frame and a predetermined number of preceding frames) and calculates the kurtosis K_{z} after the directional array process by performing the calculation of Equation (9) for the M samples of magnitudes x₁ to x_{M} of the spectrum Z over a predetermined number of frames including the target frame that is subjected to calculation of the kurtosis change index K_{R}. The index calculator 62 then calculates the ratio of the kurtosis K_{z} to the kurtosis Kₓ as the kurtosis change index K_{R} (i.e., K_{R}=K_{z}/Kₓ).

The factor adjuster 64 of FIG. 1 variably sets the subtraction factor α according to the kurtosis change index K_{R} calculated by the index calculator 62. Specifically, the factor adjuster 64 sets the subtraction factor α so that the kurtosis change index K_{R} approaches a target value K₀. As shown in FIG. 4, the kurtosis change index K_{R} increases as the subtraction factor α increases. The factor adjuster 64 increases the subtraction factor α (i.e., increases the extent of noise suppression) until the kurtosis change index K_{R} exceeds the target value K₀. That is, the target value K₀ is a numerical value (an allowable value) representing the extent to which musical noise caused by spectrum subtraction is allowed. For example, the target value K₀ is set variably according to instruction from the user (according to the extent to which musical noise is allowed by the user). However, the target value K₀ may also be set to a predetermined fixed value.

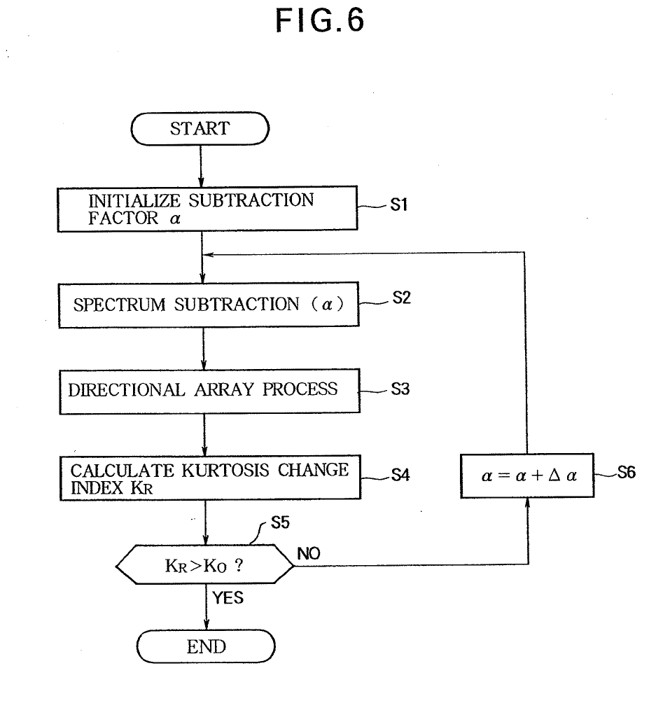

FIG. 6 is a flow chart of an operation of the noise suppression apparatus 100 in association with the adjustment of the subtraction factor α. The procedure of FIG. 6 is performed sequentially in each predetermined period (in each predetermined number of frames). When the procedure of FIG. 6 is initiated, the factor adjuster 64 initializes the subtraction factor α to a predetermined value (for example, zero) at step S1. Then at step S2, the first noise suppressor 32 generates spectrums Y[1] to Y[J] by performing spectrum subtraction using the subtraction factor α on an mth frame, which is the current frame. Further at step S3, the second noise suppressor 42 generates a spectrum Z by performing a directional array process on the spectrums Y[1] to Y[J]. The spectrum Z generated at step S3 is output to the waveform synthesizer 52. At step S4, the index calculator 62 calculates the kurtosis change index K_{R} from the spectrum Z and the spectrums X[1] to X[J] of the mth frame.

The factor adjuster 64 then determines at step S5 whether or not the kurtosis change index K_{R} calculated at step S4 has exceeded the target value K₀. When the kurtosis change index K_{R} is less than the target value K₀, the factor adjuster 64 calculates the sum of the current subtraction factor α and a predetermined value Δα as an updated subtraction factor α at step S6. At step S2 subsequent to step S6, spectrum subtraction using the updated subtraction factor α is performed on the next frame (i.e., the m+1th frame). That is, the first noise suppressor 32 subtracts the spectrum Nw[j] of stationary noise from each spectrum X[j] of the m+1th frame according to the updated subtraction factor α.

The update of the subtraction factor α (step S6), the spectrum subtraction using the updated subtraction factor α (step S2), the directional array process after spectrum subtraction (step S3), and the calculation of the kurtosis change index K_{R} (step S4) are sequentially repeated as described above. Accordingly, the subtraction factor α sequentially increases by the predetermined value Δα in each frame so that the kurtosis change index K_{R} sequentially approaches the target value K₀. The procedure of FIG. 6 is terminated when the kurtosis change index K_{R} exceeds the target value K₀ (step S5: YES). That is, the subtraction factor α updated at the immediately previous step S6 is maintained until the next round of the procedure of FIG. 6 is initiated.

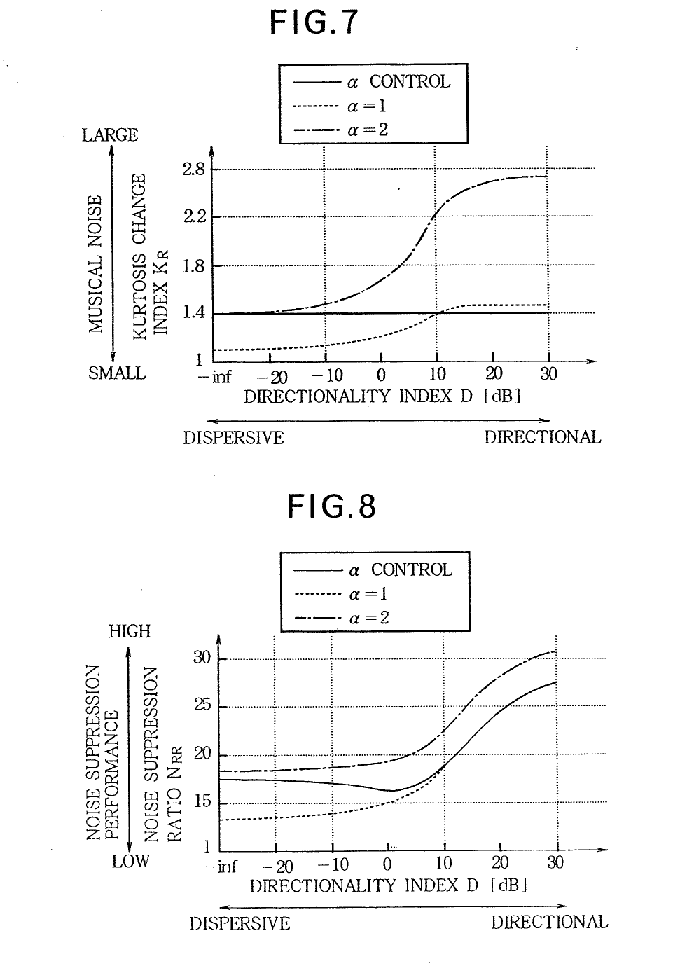

FIG. 7 is a graph illustrating a relationship between the directionality index D (horizontal axis) and the kurtosis change index K_{R} (vertical axis), and FIG. 8 is a graph illustrating a relationship between the directionality index D (horizontal axis) and the noise suppression ratio N_{RR} (vertical axis). Each of FIGS. 7 and 8 illustrates the case where the subtraction factor α is controlled through the procedure of FIG. 6 (solid line), the case where the subtraction factor α is fixed to 1 (dotted line), and the case where the subtraction factor α is fixed to 2 (dashed line).

In this embodiment, the factor adjuster 64 variably controls the subtraction factor α so that musical noise caused by spectrum subtraction of the first noise suppressor 32 is suppressed to the extent according to the target value K₀ (i.e., so that the kurtosis change index K_{R} approaches the target value K₀). In the case where the noise components include a lot of dispersive noise (i.e., the directionality index D is small), the subtraction factor α is automatically adjusted to a high value since the kurtosis change index K_{R} hardly increases (i.e., musical noise hardly occurs) even when the subtraction factor α has been increased as described above with reference to FIG. 4. Accordingly, it is possible to achieve a high noise suppression ratio N_{RR}, similar to the case where the subtraction factor α is set to 2, as shown in FIG. 8, while suppressing musical noise to the extent according to the target value K₀.

On the other hand, in the case where the noise components include a lot of directional noise (i.e., the directionality index D is high), the subtraction factor α is automatically adjusted to a low value since the kurtosis change index K_{R} easily increases (i.e., musical noise easily occurs) as the subtraction factor α increases as described above with reference to FIG. 4. However, when a lot of directional noise is present, a high noise suppression ratio N_{RR} is achieved even when the subtraction factor α is small as described above with reference to FIG. 5. Accordingly, it is possible to effectively suppress musical noise as shown in FIG. 7 while maintaining the noise suppression ratio N_{RR}, similar to when the subtraction factor α is fixed to 1. That is, this embodiment has an advantage in that it is possible to achieve both suppression of musical noise (improvement of sound quality) and improvement of the noise suppression ratio N_{RR} (improvement of the SN ratio) even in an environment in which a lot of directional noise or dispersive noise is present, compared to the case where the subtraction factor α is fixed to a predetermined value.

For example, let us assume that a mobile phone including the noise suppression apparatus 100 is used in a space such as a station yard or an exhibition hall. Operating noise of air-conditioning equipment arrives at the mobile phone as dispersive noise. A radiated sound from a sound source located distant from the mobile phone (for example, walking sound or vocal sound of another user or sound from a broadcast speaker) also arrives at the mobile phone as dispersive noise through reflection from walls or a floor in the space. On the other hand, vocal sound or walking sound of another user located near the mobile phone intermittently arrives at the mobile phone as directional noise. That is, the space such as a station yard or an exhibition hall is a typical environment in which directional noise and dispersive noise alternate in a short time interval. In such an environment, the noise suppression apparatus 100 of FIG. 1 can also effectively suppress noise components (stationary noise and non-stationary noise) while achieving both suppression of musical noise and improvement of the noise suppression ratio N_{RR} in both a period in which directional noise is dominant and a period in which dispersive noise is dominant.

<Modifications>

Various modifications can be made to each of the above embodiments. The following are specific examples of such modifications. It is also possible to arbitrarily select and combine two or more of the following modifications.

(1) Modification 1

As well as the MVDR, any known adaptive beamformer may be used to calculate the filtering factor W. For example, the invention preferably uses an SNR optimization beamformer which determines the filtering factor W so as to maximize the SN ratio of the audio signal V_{OUT} after the directional array process. Specifically, the factor setter 44 calculates an eigenvector, whose eigenvalue is maximized in an eigenvalue problem represented as the following Equation (10), as the filtering factor W(fq).

β·S_{NN}(fq)K(fq)=S_{XX}(fq)K(fq) (10)

The symbol S_{XX}(fq) of Equation (10) represents a covariance matrix of the magnitude of the component of the frequency fq in target sound components and the symbol S_{NN}(fq) of Equation (10) represents a covariance matrix of the magnitude of the component of the frequency fq in noise components. The covariance matrix S_{XX}(fq) of the target sound components is calculated using the same method as that of Equation (4) from the magnitude of the frequency (fq) in each of the spectrums X[1] to X[J] of a target sound section detected by the noise extractor 24. For example, the covariance matrix R_{NN}(fq) calculated using Equation (4) from the spectrums Nd[1] to Nd[J] of non-stationary noise is applied as the covariance matrix S_{NN}(fq) of Equation (10). In the case where the SNR optimization beamformer is used, there is an advantage in that there is no need to specify the direction (i.e., the angle ξ) of the target sound components.

(2) Modification 2

Although the method in which the subtraction factor α is sequentially updated in each frame (i.e., the subtraction factor α gradually approaches an optimal value over a plurality of frames) is described as an example with reference to FIG. 6 in the above embodiment, the invention also employs a configuration in which the subtraction factor α is set to an optimal value in each frame by repeating the procedure of steps S2 to S6 of FIG. 6 multiple times for one frame. Of course, compared to the method in which the subtraction factor α is individually optimized for each frame, the method in which the subtraction factor α is progressively updated in each frame as shown in FIG. 6 has an advantage in that the amount of processing by the noise suppression apparatus 100 is significantly reduced.

Although, in the above embodiment, the subtraction factor α is controlled so that the kurtosis change index K_{R} approaches the target value K₀ while actually performing spectrum subtraction through the first noise suppressor 32 and the filtering process (directional array process) through the second noise suppressor 42, it is also possible to analytically calculate the subtraction factor α so that the kurtosis change index K_{R} approaches the target value K₀ (i.e., to calculate the subtraction factor α without actual operation of the first noise suppressor 32 or the second noise suppressor 42). Specifically, an iterative equation, which expresses a relationship between the magnitude (second-order statistical quantity) of noise components remaining in a spectrum Z calculated through spectrum subtraction using the subtraction factor α and a filtering process using the filtering factor W and a kurtosis change index K_{R} (fourth-order statistical quantity) after the spectrum subtraction and the filtering process, is defined and a subtraction factor α which maximizes the magnitude of the noise components of the spectrum Z is calculated under a condition that the kurtosis change index K_{R} is maintained at the target value K₀, which may be considered “optimization of a second-order statistical quantity under a fourth-order statistical constraint”.

(3) Modification 3

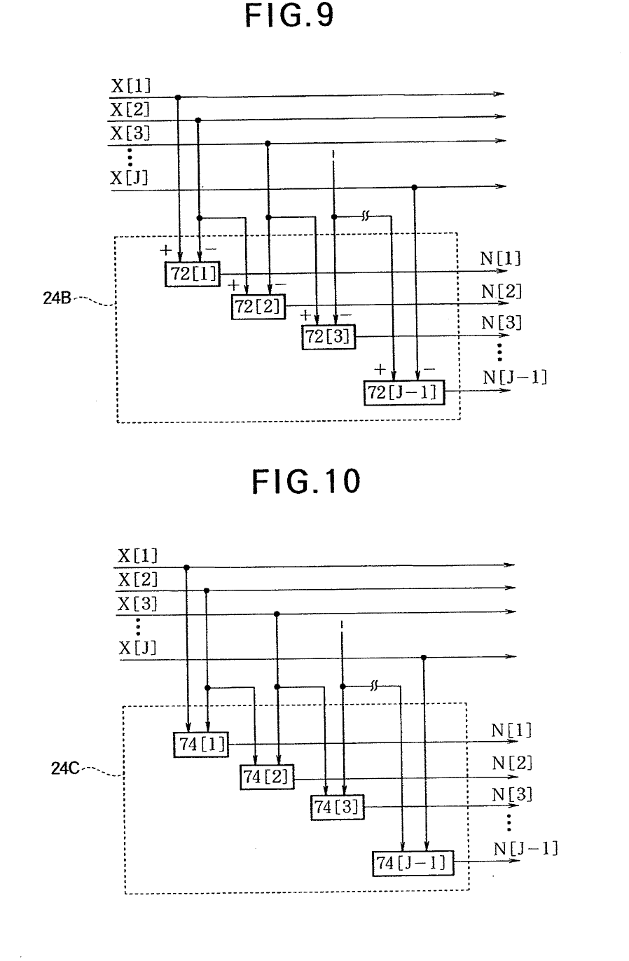

Although the spectrum Nd[j] of non-stationary noise estimated from the noise section is employed as a spectrum Nd[j] of non-stationary noise in the target sound section in the above embodiment, the invention may also employ a configuration in which the spectrum Nd[j] of non-stationary noise in the target sound section is specified directly from each frame in the target sound section. For example, the invention employs a configuration in which the noise extractor 24 of FIG. 1 is disposed in a noise extractor 24B of FIG. 9 or a noise extractor 24C of FIG. 10.

The noise extractor 24B of FIG. 9 functions as a blind angle control type beamformer that forms a sound reception blind area, which is an area with low sensitivity, in a direction (angle ξ) of arrival of target sound components. For example, when the angle ξ of target sound components is zero, the noise extractor 24B includes (J−1) subtractors 72[1] to 72[J−1] corresponding to combinations of two adjacent sound collecting devices among the J sound collecting devices 12[1] to 12[J] (of the J channels) as shown in FIG. 9. The subtractor 72[j] suppresses target sound components of the angle ξ by subtracting the audio signal V[j+1] (spectrum X[j+1]) from the audio signal V[j] (spectrum X[j]). Accordingly, noise component spectrums N[1] to N[J−1] are output from the noise extractor 24B.

The noise extractor 24C of FIG. 10 includes (J−1) separators 74[1] to 74[J−1] corresponding to combinations of two adjacent sound collecting devices among the J sound collecting devices 12[1] to 12[J]. The separator 74[j] generates a noise component spectrum N[j] through independent component analysis (ICA) using the audio signal V[j] (spectrum X[j]) and the audio signal V[j+1] (spectrum X[j+1]). Specifically, the separator 74[j] extracts noise components by applying a separation matrix, which is set so that target sound components and noise components are statistically independent, a filtering process (sound source separation) of the audio signal V[j] and the audio signal V[j+1]. Accordingly, the noise component spectrums N[1] to N[J−1] are output from the noise extractor 24C.

In both the configurations of FIGS. 9 and 10, the stationary noise estimator 26 generates J−1 number of spectrums Nw[1] to Nw[J−1] by time-averaging the spectrums N[1] to N[J−1], respectively. Then, the first noise suppressor 32 generates J−1 number of spectrums Y[1] to Y[J−1] by subtracting the spectrum Nw[j] from J−1 channels of audio signals V (for example, the audio signals V[1] to V[J−1]) among the audio signals V[1] to V[J] of the J channels. On the other hand, the non-stationary noise estimator 34 generates J−1 number of spectrums Nd[1] to Nd[J−1] by subtracting the stationary noise spectrum Nw[j] from the spectrums N[1] to N[J−1], respectively. Accordingly, a filtering factor W that the factor setter 44 generates through calculation of Equation (3) is a matrix of J−1 rows and 1 column. The second noise suppressor 42 performs a filtering process applying the filtering factor W to the J−1 number of spectrums Y[1] to Y[J−1] generated by the first noise suppressor 32.

Since the non-stationary noise spectrums Nd[1] to Nd[J−1] are extracted directly from each frame of the target sound section, the configurations of FIGS. 9 and 10 can set a filtering factor W capable of suppressing non-stationary noise with high accuracy, compared to the configuration of FIG. 1 in which the spectrum Nd[j] in the noise section is applied to the target sound section.

(4) Modification 4

The definition of the kurtosis change index K_{R} is not limited to the above example (i.e., the ratio between the kurtosis K_{X} and the kurtosis K_{Z}). For example, the invention also preferably employs a configuration in which the difference between the kurtosis K_{X} and the kurtosis K_{Z} is calculated as the kurtosis change index K_{R} (i.e., K_{R}=K_{Z}−K_{X}) or a configuration in which a value of a predetermined function whose variables are the kurtosis K_{X} and the kurtosis K_{Z} is calculated as the kurtosis change index K_{R} (for example, a configuration in which a logarithmic value of the ratio between the kurtosis K_{X} and the kurtosis K_{Z} or the difference between the kurtosis K_{X} and the kurtosis K_{Z} is used as the kurtosis change index K_{R}). Although the kurtosis K_{X} is calculated from the audio signals V[1] to V[J] in the above embodiments, the invention also employs a configuration in which the kurtosis K_{X} is calculated from only one audio signal V[j] selected from the audio signals V[1] to V[J] of the J channels.

Although the above embodiments have been described with reference to an example in which the kurtosis change index K_{R} increases as the kurtosis K_{Z} increases, relative to the kurtosis K_{X}, the invention also employs a configuration in which the kurtosis change index K_{R} is defined such that the kurtosis change index K_{R} decreases as the kurtosis K_{Z} increases, relative to the kurtosis K_{X}. As is understood from the above examples, the kurtosis change index K_{R} serves as a measure of the amount of change of the kurtosis of the frequence distribution of the signal magnitude from the first kurtosis observed when the processing of the first noise suppressor 32 is performed to the second kurtosis observed when the processing of the second noise suppressor 42 is performed, and the method of calculation of the kurtosis change index K_{R} (definition thereof) is arbitrary.

(5) Modification 5

Although the processes from the process of the frequency analyzer 22 to the process of the waveform synthesizer 52 are performed in the frequency domain, the processes other than the spectrum subtraction by the first noise suppressor 32 may be appropriately changed to signal processes of the time domain. For example, the invention employs a configuration in which the index calculator 62 calculates the kurtosis K_{X} from each magnitude of the audio signal V_{OUT} of the time domain or a configuration in which the index calculator 62 calculates the kurtosis K_{Z} from each magnitude of the audio signal V_{OUT} of the time domain. The processes of the noise extractor 24 or the stationary noise estimator 26 may also be performed in the time domain.

(6) Modification 6

Although the stationary noise spectrum Nw[j] is generated for each channel of the audio signal V[j] in each of the above embodiments, the invention may also employ a configuration in which a common spectrum Nw (for example, the average of the spectrums Nw[1] to Nw[J] of FIG. 1) is generated for a plurality of channels. The first noise suppressor 32 generates spectrums Y[1] to Y[J] by subtracting the common stationary noise spectrum Nw from each of the spectrums X[1] to X[J] and the non-stationary noise estimator 34 generates spectrums Nd[1] to Nd[J] by subtracting the common spectrum Nw from each of the noise component spectrums N[1] to N[J].

What is claimed is:

1. An apparatus for suppressing noise components from audio signals of a plurality of channels generated by a plurality of sound collecting devices, the apparatus comprising:
a noise extraction part that extracts a noise component from an audio signal of each of the plurality of channels;
a stationary noise estimation part that estimates stationary noise included in the noise component;
a first noise suppression part that removes a spectrum of the stationary noise from a spectrum of the audio signal of each of the plurality of channels to an extent determined by a subtraction factor;
a non-stationary noise estimation part that estimates a spectrum of non-stationary noise by subtracting the spectrum of the stationary noise from the spectrum of the noise component of each of the plurality of channels;
a factor setting part that generates a filtering factor for emphasizing a target sound component contained in the audio signal from the spectrum of the non-stationary noise;
a second noise suppression part that performs a filtering process using the filtering factor on the audio signals of the plurality of channels after processing of the first noise suppression part;
an index calculation part that calculates a kurtosis change index representing an extent of change of kurtosis in a frequence distribution of magnitude of each of the audio signals between the kurtosis observed when processing of the first noise suppression part is performed and the kurtosis observed when processing of the second noise suppression part is performed; and
a factor adjustment part that variably controls the subtraction factor according to the kurtosis change index.

2. The apparatus according to claim 1, wherein the factor adjustment part controls the subtraction factor such that the kurtosis change index approaches a predetermined value.

3. The apparatus according to claim 2, wherein the factor adjustment part controls the subtraction factor such that the kurtosis change index approaches a predetermined value which represents an extent to which musical noise caused by the first noise suppression part is allowed.

4. A machine readable storage medium being provided for use in a computer and containing program instructions executable by the computer to perform:
a noise extraction process of extracting a noise component from an audio signal of each of a plurality of channels generated by a plurality of sound collecting devices;
a stationary noise estimation process of estimating stationary noise included in the noise component;
a first noise suppression process of removing a spectrum of the stationary noise from a spectrum of the audio signal of each of the plurality of channels to an extent determined according to a subtraction factor;
a non-stationary noise estimation process of estimating a spectrum of non-stationary noise by subtracting the spectrum of the stationary noise from the spectrum of the noise component of each of the plurality of channels;
a factor setting process of generating a filtering factor for emphasizing a target sound component contained in the audio signal from the spectrum of the non-stationary noise;
a second noise suppression process of performing a filtering process using the filtering factor on the audio signals of the plurality of channels after the first noise suppression process is performed;
an index calculation process of calculating a kurtosis change index representing an extent of change of kurtosis in a frequence distribution of magnitude of each of the audio signals between the kurtosis observed when the first noise suppression process is performed and the kurtosis observed when the second noise suppression process is performed; and
a factor adjustment process of variably controlling the subtraction factor according to the kurtosis change index.
